(19) United States
(12) Patent Application Publication
(10) Pub. No.: US 2025/0273199 A1
(43) Pub. Date: Aug. 28, 2025

(54) INFORMATION PROCESSING DEVICE, TRAINING DEVICE, INFORMATION PROCESSING METHOD, TRAINING METHOD, AND RECORDING MEDIUM

(71) Applicants: Mitsubishi Electric Corporation, Tokyo (JP); MITSUBISHI ELECTRIC RESEARCH LABORATORIES, INC., Cambridge, MA (US)

(72) Inventors: Yoshiki MITSUI, Tokyo (JP); Ryo Aihara, Tokyo (JP); Takaaki Hori, Cambridge, MA (US); Jonathan Le Roux, Cambridge, MA (US)

(73) Assignees: Mitsubishi Electric Corporation, Tokyo (JP); MITSUBISHI ELECTRIC RESEARCH LABORATORIES, INC., Cambridge, MA (US)

(21) Appl. No.: 18/589,109

(22) Filed: Feb. 27, 2024

(51) Int. Cl. G10L 15/06; G06F 16/34; G10L 15/26

(52) U.S. Cl. CPC G10L 15/063; G06F 16/345; G10L 15/26

(57) ABSTRACT

A processor performs, using a bias module, an increasing process of increasing the likelihood of a candidate symbol that includes a registered symbol, among at least one candidate symbol. The processor determines a temporary output symbol based on a respective likelihood of the at least one candidate symbol after the increasing process is performed. When the registered symbol is included in the temporary output symbol, the processor refers to a combination table, performs a transformation process of transforming the registered symbol into a specific symbol corresponding to the registered symbol, and outputs, as an output symbol, the temporary output symbol on which the transformation process has been performed.

### TECHNICAL FIELD

The present disclosure relates to an information processing device, a training device, an information processing method, a training method, and a recording medium.

### BACKGROUND ART

In recent years, an information processing device which performs a transformation process of transformation from input data into an output symbol is exploited in various fields. In particular, an end-to-end structure is known, in which the transformation process is performed using a single neural network.

For example, an information processing device employing a voice recognition engine receives an input of voice data as input data. The information processing device outputs text of the voice as an output symbol. Note that a symbol (output symbol) is a word or text, for example.

In the meantime, the voice recognition engine has a priority output feature which allows a specific symbol to be preferentially output as an output symbol. In the priority output feature, for example, a user registers a specific symbol indicating a proper noun such as a name of a person or a place name with the voice recognition engine. The voice recognition engine preferentially outputs the specific symbol upon voice recognition. The priority output feature is also referred to as a lexical entry feature.

In a conventional voice recognition engine, the lexical entry feature is an independent feature and thus readily implemented. In the voice recognition engine having the end-to-end structure, however, a single neural network is used to implement the transformation of the input data into an output symbol sequence. Accordingly, it is difficult for a partially-changed word to be additionally registered with the voice recognition engine of the end-to-end structure.

To address this problem, Japanese Patent Laying-Open No. 2022-531615 (PTL 1) discloses a voice recognition engine which limits the problem. The voice recognition engine causes an end-to-end voice recognition model and a weighted finite-state transducer (WFST) to coordinate with each other. The voice recognition engine limits the problem by facilitating, through the coordination, a specific word to appear as a voice recognition result.

### CITATION LIST

### Patent Literature

PTL 1: Japanese Patent Laying-Open No. 2022-531615

### SUMMARY OF INVENTION

### Technical Problem

As with PTL 1, when the configuration, in which the end-to-end model and WFST are combined to facilitate a specific symbol to be output, is applied to a voice recognition engine, a symbol that is not included in training data for the end-to-end model may not be output as an output symbol. In the technology disclosed in PTL 1, a replacement process is performed to train the voice recognition model. In the replacement process, any symbol in the training data is randomly replaced with a different symbol that has the same pronunciation. The replacement process results in generation of a new symbol as new training data. The technology of PTL 1 discloses a method for limiting the above problem by diversifying the training data as such.

However, in the replacement process, it is difficult for a user or the like to previously cover the words that will be generated in the future. Accordingly, even though a specific symbol is registered, it is often the case that the specific symbol is not generated by the replacement process. In this case, a problem can arise that the specific symbol registration may not be output as an output symbol. In other words, with a conventional information processing device, it is difficult for a specific symbol, which is input by the user, to be preferentially output as an output symbol.

An object of the present disclosure is made to solve the problem as described above, and is to provide a technology that enables a specific symbol, input by a user, to be preferentially output as an output symbol.

### Solution to Problem

An information processing device according to the present disclosure is an information processing device for transforming input data into an output symbol and outputting the output symbol. The information processing device includes: an interface for receiving a user input of the input data; a memory storing a trained model; and a processor. The processor extracts a feature value from the input data. The processor applies the feature value to the trained model to estimate at least one candidate symbol and a likelihood of the at least one candidate symbol. The memory stores a combination table and a bias module. The combination table indicates a combination of a specific symbol designated by the user and a registered symbol corresponding to the specific symbol. The bias module increases a likelihood of a candidate symbol that includes the registered symbol. The processor further: performs, using the bias module, an increasing process of increasing the likelihood of the candidate symbol that includes the registered symbol, among the at least one candidate symbol. The processor determines a temporary output symbol based on a respective likelihood of the at least one candidate symbol after the increasing process is performed. When the registered symbol is included in the temporary output symbol, the processor refers to the combination table, performs a transformation process of transforming the registered symbol into the specific symbol corresponding to the registered symbol, and outputs, as the output symbol, the temporary output symbol on which the transformation process has been performed.

A training device according to the present disclosure is a training device for updating a model. The training device includes: an interface for obtaining training data, the training data being a combination of training input data and a first training output symbol; and a processor. The processing device extracts a feature value from the training input data. The processing device applies the feature value to the model to obtain an output symbol. The processing device performs a pre-process on the first training output symbol to generate a second training output symbol. The processing device updates the model so that an error between the output symbol and the second training output symbol diminishes. The pre-process is a process in which: a first symbol included in the first training output symbol; and a second symbol in which the first symbol is expressed in a way designated by a user are generated.

An information processing method according to the present disclosure is an information processing method for transforming input data into an output symbol and outputting the output symbol. A bias module increases a likelihood of a candidate symbol that includes a registered symbol. A combination table indicates a combination of a specific symbol designated by a user and a registered symbol corresponding to the specific symbol. The information processing method includes extracting a feature value from the input data. The information processing method includes applying the feature value to a trained model to estimate at least one candidate symbol and a likelihood of the at least one candidate symbol. The information processing method includes performing, using the bias module, an increasing process of increasing the likelihood of the candidate symbol that includes the registered symbol corresponding to the specific symbol designated by the user, among the at least one candidate symbol. The information processing method includes performing, using the bias module, an increasing process of increasing the likelihood of the candidate symbol that includes the registered symbol, among the at least one candidate symbol. The information processing method includes determining a temporary output symbol based on a respective likelihood of the at least one candidate symbol after the increasing process is performed. When the registered symbol is included in the temporary output symbol, referring to the combination table, the information processing method includes performing a transformation process of transforming the registered symbol into the specific symbol corresponding to the registered symbol, and outputting, as the output symbol, the temporary output symbol on which the transformation process has been performed.

A training method according to the present disclosure is a training method for updating a model. The training method includes obtaining training data, the training data being a combination of training input data and a first training output symbol. The training method includes extracting a feature value from the training input data. The training method includes applying the feature value to the model to obtain an output symbol. The training method includes performing a pre-process on the first training output symbol to generate a second training output symbol. The training method includes updating the model so that an error between the output symbol and the second training output symbol diminishes. The pre-process is a process in which: a first symbol included in the first training output symbol; and a second symbol in which the first symbol is expressed in a way designated by a user are generated.

A recording medium according to the present disclosure is a non-transitory recording medium storing a program for causing a computer to transform input data into an output symbol and output the output symbol. A bias module increases a likelihood of a candidate symbol that includes a registered symbol. A combination table indicates a combination of a specific symbol designated by a user and a registered symbol corresponding to the specific symbol. The program causes the computer to extract a feature value from the input data. The program causes the computer to apply the feature value to a trained model to estimate at least one candidate symbol and a likelihood of the at least one candidate symbol. The program causes the computer to perform, using the bias module, an increasing process of increasing the likelihood of the candidate symbol that includes the registered symbol corresponding to the specific symbol designated by the user, among the at least one candidate symbol. The program causes the computer to perform, using the bias module, an increasing process of increasing the likelihood of the candidate symbol that includes the registered symbol, among the at least one candidate symbol. The program causes the computer to determine a temporary output symbol based on a respective likelihood of the at least one candidate symbol after the increasing process is performed. When the registered symbol is included in the temporary output symbol, the program causes the computer to refer to the combination table, perform a transformation process of transforming the registered symbol into the specific symbol corresponding to the registered symbol, and output, as the output symbol, the temporary output symbol on which the transformation process has been performed.

A recording medium according to the present disclosure is a non-transitory recording medium storing a program for causing a computer to update a model. The program causes the computer to obtain training data, the training data being a combination of training input data and a first training output symbol. The program causes the computer to extract a feature value from the training input data. The program causes the computer to apply the feature value to the model to obtain an output symbol. The program causes the computer to perform a pre-process on the first training output symbol to generate a second training output symbol. The program causes the computer to update the model so that an error between the output symbol and the second training output symbol diminishes. The pre-process is a process in which: a first symbol included in the first training output symbol; and a second symbol in which the first symbol is expressed in a way designated by a user are generated.

### Advantageous Effects of Invention

According to the present disclosure, the technology can be provided which enables a specific symbol input by a user to be preferentially output as an output symbol.

### BRIEF DESCRIPTION OF DRAWINGS

FIG. 1 is a diagram for illustrating an overview of an information processing device according to the present disclosure.

FIG. 2 is a block diagram showing a hardware configuration of the information processing device.

FIG. 3 is a functional block diagram of an information processing system.

FIG. 4 is a functional block diagram of the information processing device.

FIG. 5 is a diagram illustrating one example of a specific symbol table.

FIG. 6 is a diagram illustrating one example of a combination table.

FIG. 7 is a diagram illustrating one example of a bias table.

FIG. 8 is a flowchart illustrating a primary processing by the information processing device.

FIG. 9 is a functional block diagram of a training device.

FIG. 10 is a diagram illustrating one example of a word change process.

FIG. 11 is a diagram illustrating one example of a pre-process.

FIG. 12 is a flowchart of the training device.

FIG. 13 is one example of a specific symbol table expressed in Japanese.

FIG. 14 is one example of a combination table expressed in Japanese.

FIG. 15 is one example of a bias table expressed in Japanese.

FIG. 16 is a diagram showing other application of input data.

FIG. 17 is a diagram illustrating one example of a probable symbol.

FIG. 18 is a flowchart for a registered symbol determination technique.

### DESCRIPTION OF EMBODIMENTS

Hereinafter, an embodiment according to the present disclosure will be described, with reference to the accompanying drawings. In the following, a number of embodiments are described. The configurations described in the respective embodiments are intended to be combined as appropriate in the application as initially filed. Note that the same reference signs are used to refer to the same or like parts, and the description thereof will not be repeated.

### Embodiment 1

### [Overview of Present Disclosure]

Hereinafter, a term “symbol” will be used. The symbol is a unit of information that is output from an information processing device 100. For example, a symbol indicates at least one character. The character is, for example, hiragana, katakana, kanji, and an alphabet, etc. For example, the symbol may be one character (e.g., “A”) or multiple characters, for example, “America.” Where the symbol is defined as one character, multiple characters will also be referred to as a “symbol sequence.” The symbol may also be information indicating an event such as the beginning of the symbol and the end of the symbol.

In the following disclosure, the information indicating one character and the information indicating multiple characters will be collectively referred to as a “symbol.” In other words, “A” and “America” are both a “symbol.”

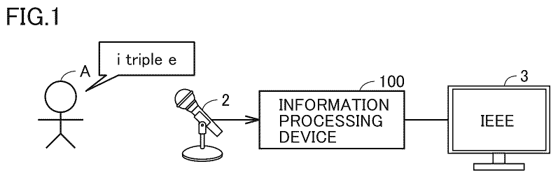

FIG. 1 is a diagram for illustrating an overview of the information processing device 100 according to the present disclosure. In the example of FIG. 1, the information processing device 100, a microphone 2 (a voice input device), and a display 3 (a display device) are shown. The microphone 2 and the display 3 are connected to the information processing device 100.

In the example of FIG. 1, a user A is uttering a voice “i triple e.” The “i triple e” means “IEEE.” Note that “IEEE” is a symbol (word) indicating a group called “Institute of Electrical and Electronics Engineers,” and is one example of a proper noun. The information processing device 100 receives an input of voice data of the voice “i triple e,” performs a voice recognition process, and outputs text data of “IEEE” as an output symbol. The display 3 shows the text data “IEEE.”

The user A registers “IEEE” as a specific symbol with the information processing device 100, and wishes “IEEE” to be preferentially output as an output symbol when the user A utters the voice “i triple e.”

In the example of FIG. 1, the output symbol includes “IEEE” which is desired by the user to be output. However, for example, a conventional voice recognition apparatus may show on the display 3 the text “i triple e,” which is the sound as uttered. The information processing device 100 according to the present embodiment employs an end-to-end structure.

### [Hardware Configuration of Information Processing Device]

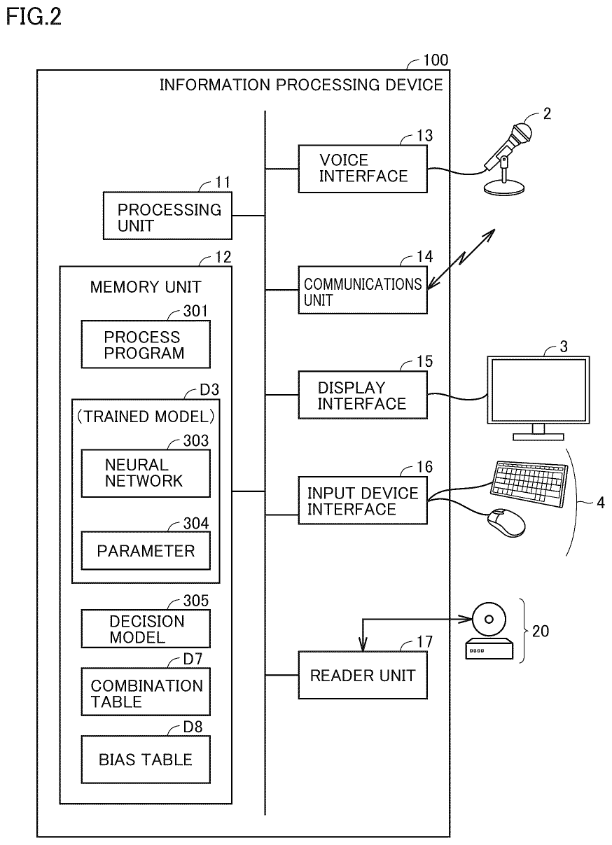

FIG. 2 is a block diagram showing a hardware configuration of the information processing device 100 according to Embodiment 1. The information processing device 100 may be implemented in, for example, a general-purpose computer or a dedicated computer.

As shown in FIG. 2, the information processing device 100 includes a processing unit 11, a memory unit 12, a voice interface 13, a communications unit 14, a display interface 15, an input device interface 16, and a reader unit 17 as primary hardware elements.

The processing unit 11 is a processing entity (a processing device) which executes various programs to perform various processes. The processing unit 11 is one example of a computer. The processing unit 11 corresponds to a “processor” according to the present disclosure. The processing unit 11 is configured of, for example, a central processing unit (CPU), a field-programmable gate array (FPGA), and a graphics processing unit (GPU). Note that the processing unit 11 may be configured of at least one of the CPU, FPGA, and GPU, or the CPU and FPGA, the FPGA and GPU, the CPU and GPU, or all of the CPU, FPGA, and GPU. The processing unit 11 will also be referred to as “at least one the processor.” The processing unit 11 may also be configured of a processing circuitry. Note that the processing unit 11 may be configured of one chip or multiple chips. Furthermore, all or some of the functions of the processing unit 11 may be provided at a server device (e.g., a cloud server device) not shown.

The memory unit 12 includes a volatile memory area (e.g., a working area) for temporarily storing a program code and a work memory in executing arbitrary programs. For example, the memory unit 12 is configured of a volatile memory device such as a dynamic random access memory (DRAM) or a static random access memory (SRAM). The memory unit 12 further includes a non-volatile memory area. For example, the memory unit 12 is configured of a nonvolatile memory device such as a read only memory (ROM), a hard disk, or a solid state drive (SSD).

In the present embodiment, the volatile memory area and the non-volatile memory area are included in the same memory unit 12. However, the volatile memory area and the non-volatile memory area may be included in mutually different memory units. For example, the processing unit 11 may include the volatile memory area and the memory unit 12 may include the non-volatile memory area. The information processing device 100 may include a microcomputer which includes the processing unit 11 and the memory unit 12.

The memory unit 12 stores a process program 301, a trained model D3, a decision model 305, a combination table D7, and a bias table D8. The process program 301 includes a generation program and a training program. An information process is written in the information processing program, in which information process an output text is generated based on the trained model D3 and voice data (input data) obtained by the processing unit 11 through the microphone 2. A training process, in which the trained model D3 is updated (trained), is written in the training program.

The trained model D3 includes a neural network 303 and a parameter 304 used by the neural network 303. Multiple training data, which are a combination of training input data and a training output symbol, are used to perform machine learning (the update process) on the trained model D3.

The trained model D3 has, for example, a well-known deep neural network (DNN), convolutional neural network (CNN), long short-term memory (LSTM), Transformer, Conformer structure, etc. The decision model 305, the combination table D7, and the bias table D8 will be described below.

The voice interface 13 is an interface for connecting the microphone 2. The communications unit 14 communicates with a predetermined external device. The display interface 15 is an interface for connecting the display 3, and implements input/output of data between the information processing device 100 and the display 3.

The input device interface 16 is an interface for connecting the input device 4 (e.g., a keyboard and a mouse, etc.), and implements input/output of data between the information processing device 100 and the input device.

The reader unit 17 reads various data stored in a removable disk 20, which is a storage medium. The removable disk 20 stores the process program 301 (at least one of the information processing program and the training program) according to the present disclosure. The removable disk 20 storing the process program 301 is for sale, for example. The reader unit 17 may also obtain the process program 301 from the removable disk 20. The removable disk 20 corresponds to one example of a “non-transitory recording medium” according to the present disclosure.

### [Functional Block Diagram of Information Processing System]

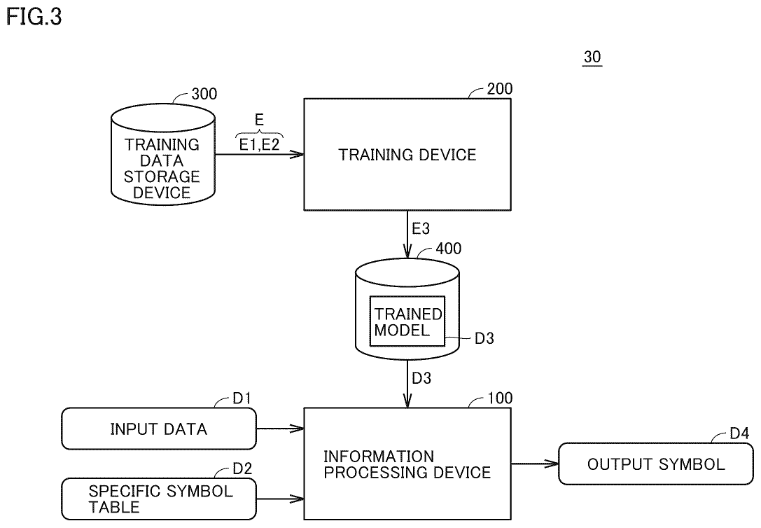

FIG. 3 is a functional block diagram of the information processing system 30. The information processing system 30 includes the information processing device 100, the training device 200, a training data storage device 300, and a trained model storage device 400. Using the trained model D3, the information processing device 100 outputs an output symbol D4, based on input data D1 and a specific symbol table D2.

The training device 200 trains the trained model D3 (updates the parameter 304), which is to be used by the information processing device 100. The training device 200 uses training data E stored in the training data storage device 300 to train the model. A trained model E3, which is a trained model, is output to the trained model storage device 400.

### [Functional Block Diagram of Information Processing Device]

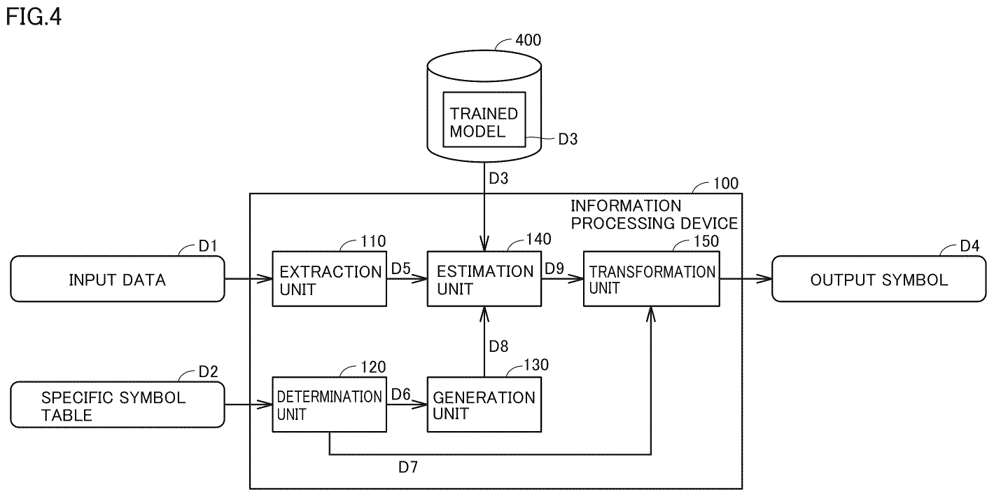

FIG. 4 is a functional block diagram of the information processing device 100. The information processing device 100 has an extraction unit 110, a determination unit 120, a generation unit 130, an estimation unit 140, and a transformation unit 150.

The information processing device 100 according to the present embodiment functions as a voice recognition apparatus. The input data D1 and the specific symbol table D2 are input to the information processing device 100. In the present embodiment, the input data D1 is voice data. The input data D1 is, for example, a digital signal into which the voice input to the microphone 2 is transformed through analog-to-digital transformation by the microphone 2. The output symbol D4 is data text of the voice represented by the voice data. For example, the specific symbol table D2 is input to the information processing device 100 by the user through the input device 4, prior to the input of the input data D1 to the information processing device 100.

The input data D1 is input to the extraction unit 110. The extraction unit 110 extracts from the input data D1 a feature value D5 that is in a form suitable for input to the trained model D3. The method of extraction of the feature value D5 includes, for example, a step of splitting an audio signal, which is the input data D1, for each overlapping period of time. The method of extraction further includes a process of extraction of a well-known log mel filterbank or mel frequency cepstral from the split signal. The method of extraction of feature value may be other method.

The feature value D5 is output to the estimation unit 140. The estimation unit 140 applies the feature value D5 to the trained model D3 to estimate at least one candidate symbol and a likelihood of the at least one candidate symbol. The likelihood is a parameter indicating a likelihood of a candidate symbol, and also referred to as a score. As the score, for example, a negative log-likelihood (NLL) is used. Where the score is the negative log-likelihood, the smaller the score is, the higher the likelihood is. In the present embodiment, the smaller the score is, the higher the likelihood is. In an alternative embodiment, the greater the score is, the higher the likelihood may be.

The estimation unit 140 further performs an increasing process of increasing the likelihood (a process of reducing a score), using a bias table D8 described below. The estimation unit 140 outputs a candidate bias which has a largest likelihood after the performance of the increasing process, as a temporary output symbol D9.

Next, the specific symbol table D2 is described. The specific symbol table D2 is a table storing at least one specific symbol. The specific symbol is, for example, a symbol which tends to be not included in the output symbol D4 when the information processing device 100 performs the voice recognition process on the input text, without using the bias table D8 described below. Given such a tendency, the specific symbol is, typically, a symbol that is desired by the user to be preferentially included in the output symbol D4. The specific symbol is a proper noun or a text that includes a special meaning, for example. The specific symbol table D2 is the information which is previously input to the information processing device 100 by the user A or the like prior to the input of the input data D1 to the information processing device 100.

A registered symbol, described below, is a symbol corresponding to the specific symbol. For example, the registered symbol has the same meaning as the specific symbol but is expressed in a different way (expression type) than the specific symbol. The registered symbol can include a symbol which has the same pronunciation as the specific symbol, which is a word, but different in reading in any one of hiragana, katakana, romaji, or the spelling from the specific symbol. The registered symbol can also include a symbol by which the specific symbol is expressed in international phonetic alphabets, for example. As such, the registered symbol has the same reading as the specific symbol, but can be expressed using a different symbol from the specific symbol. Note that the registered symbol and the specific symbol may be the same.

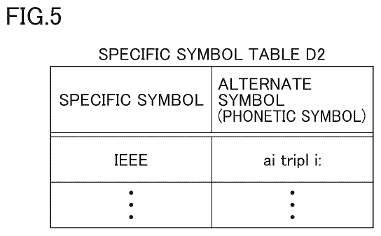

FIG. 5 is one example of the specific symbol table D2. The specific symbol is, for example, a proper noun such as a name of person or a place name, or an organization's name such as “IEEE” noted above. In the specific symbol table, the specific symbol (IEEE) and a phonetic symbol of the specific symbol, as an alternate symbol to the specific symbol, are associated with each other. The alternate symbol may not exist.

The determination unit 120 determines a registered symbol from the input specific symbol table D2. The registered symbol is a symbol that is preferentially output from the estimation unit 140, instead of a specific symbol. Note that “a symbol being preferentially output” refers to a candidate symbol (described below), which is the symbol, having a high likelihood. As such, in the present embodiment, preferably, the registered symbol has a high likelihood.

Next, the determination unit 120 extracts a specific symbol from the specific symbol table. The determination unit 120 transforms the specific symbol into a registered symbol.

Note that the technique of transformation from a specific symbol to a registered symbol employs a technique for determining the registered symbol based on supplemental information (not shown) included in the specific symbol table D2. The transformation technique may also be implemented by predetermined operations. The transformation technique may also be implemented by the user designating the expression type of a registered symbol, for example. An alternative symbol may be determined as the registered symbol.

The determination unit 120 combines the specific symbol and the registered symbol and generates the combination table D7. The combination table D7 shows the combination of a specific symbol input by the user and the registered symbol corresponding to the specific symbol.

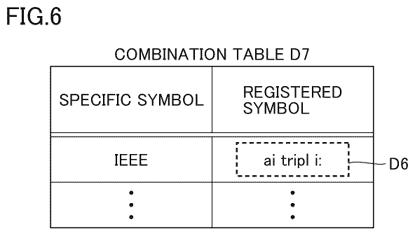

FIG. 6 is a diagram illustrating one example of the combination table D7. In the combination table D7, “IEEE,” which is a specific symbol, and a phonetic symbol (the registered symbol) for the specific symbol are associated with each other. The combination table D7 is stored in the memory unit 12 (FIG. 2). The combination table D7 is output to a transformation unit 150 described below.

The determination unit 120 extracts a registered symbol D6 from the combination table D7 and outputs the registered symbol D6 to the generation unit 130. The registered symbol D6 is the symbol in the dotted box of FIG. 6.

The generation unit 130 determines a bias value corresponding to the registered symbol D6 included in the combination table D7 and generates the bias table D8. The bias table D8 corresponds to one example of a “bias module” according to the present disclosure. In the bias table D8, the registered symbol and a bias value for increasing the likelihood are defined in association with each other. The bias table D8 generated by the generation unit 130 is stored into the memory unit 12.

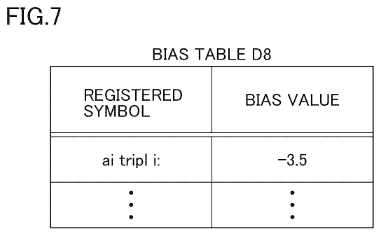

FIG. 7 is one example of the bias table. In the example of FIG. 7, the phonetic symbol (the registered symbol D6) of IEEE is associated with a bias value “−3.5.” Other registered symbols are also associated with bias values.

An assumption can be applied that if a small amount of registered symbols are included in a training output symbol included in the training data E for the trained model D3, the trained model D3 is trained so that a symbol that includes the registered symbol has a less likelihood than a symbol that includes a symbol that differs from the registered symbol.

Here, “i triple e” is divided into a word “i,” a word “triple,” and a word “e,” and many of these words are included in the training data E. Accordingly, more of “i triple e” is included in the training data E than the phonetic symbol of IEEE. Accordingly, as shown in FIG. 1, where “i triple e” is the input data D1, there is a tendency (assumption) that “i triple e” has a smaller score than the phonetic symbol of IEEE (“i triple e” has a higher likelihood than the phonetic symbol). Note that “i triple e” will also be referred to as a “general word.”

Under such an assumption, the bias value is set so that the estimation unit 140 estimates a smaller score for the phonetic symbol than “i triple e.” In other words, as a guidance in determining the bias value, the generation unit 130 determines the bias value configured in such a manner that the symbol that is included in lower amount in the training data E has a greatly reduced score (increased likelihood).

For example, the generation unit 130 uses the decision model 305 (see FIG. 2) to determine the bias value. For example, the decision model 305 is created, using a training symbol DT2, and includes a language model. For example, an N-gram language model is employed as the language model. The language model outputs a larger negative log-likelihood for the symbol that is included in lower amount in the training symbol DT2, and outputs a smaller negative log-likelihood for the symbol that is included in larger amount in the training symbol DT2. The decision model 305 can be represented by Equation (1):

$$bias value = ρ - λ \times ( negative log - likelihood from language model ) \qquad ( 1 )$$

Here, ρ is a constant, and λ is a positive constant. As such, using the decision model 305 by Equation (1), the generation unit 130 outputs the bias value that is configured in such a manner that the less the number of input registered symbols are included in the training registered symbol, the greater the likelihood of a candidate symbol that includes the registered symbol is. For example, if a small number of input registered symbols are included in the training registered symbol, the bias value is −5. If a large number of input registered symbols are included in the training registered symbol, the bias value is −1. Note that the input registered symbol is a registered symbol input to the decision model 305.

Note that the bias table may be generated in a WFST format described above. A machine learning model may be used, rather than the language model.

Next, a process of the estimation unit 140 using the bias table D8 is described. As described above, the estimation unit 140 applies the feature value D5 to the trained model D3 to estimate at least one candidate symbol and a likelihood of the at least one candidate symbol. If the bias table D8 does not exist, the estimation unit 140 identifies and outputs a candidate symbol that has a smallest score (a highest likelihood), among the at least one candidate symbol, to the temporary output symbol D9.

If the bias table D8 exists, in contrast, the estimation unit 140 adds the bias value corresponding to the registered symbol in the bias table D8 to the score of the candidate symbol that includes the registered symbol.

For example, a description is given where the estimation unit 140 identifies the following first candidate symbol and second candidate symbol as candidate symbols. Assume that the first candidate symbol is “i triple e,” and the first candidate symbol has a score “0.0.” Assume that the second candidate symbol is “the phonetic symbol of IEEE,” and the second candidate symbol has a score “1.0.” In this example, the first candidate symbol has a smaller score (a higher likelihood) than the second candidate symbol.

In this example, if the bias table D8 does not exist, the estimation unit determines the first candidate symbol as a temporary output symbol.

In this example, if the bias table D8 of FIG. 7 exists, in contrast, the second candidate symbol is registered as a registered symbol. Accordingly, the estimation unit 140 performs the increasing process of increasing the likelihood of the candidate symbol (the second candidate symbol) based on the bias value (−3.5) corresponding to the registered symbol. In this example, the increasing process is a process in which a process of adding the bias value to the score is performed to determine the score to be −2.5.

As such, the estimation unit 140 performs the increasing process of increasing the likelihood of the candidate symbol that includes a registered symbol, among the at least one candidate symbol, based on the bias value corresponding to the registered symbol.

The temporary output symbol D9 is determined based on the likelihood of the at least one candidate symbol after the performance of the increasing process. In the above example, after the increasing process, the first candidate symbol has a score “0.0,” and the second candidate symbol has a score “−2.5.” Accordingly, the estimation unit 140 determines the second candidate symbol as the temporary output symbol D9. The temporary output symbol D9 is input to the transformation unit 150.

The transformation unit 150 refers to the combination table D7 (FIG. 6) if the registered symbol is included in the temporary output symbol D9. The transformation unit 150 performs the transformation process of transforming the registered symbol into a specific symbol corresponding to the registered symbol. The transformation unit 150 outputs the temporary output symbol D9, on which the transformation process has been performed, as the output symbol D4.

In the above example, “the phonetic symbol of IEEE” is included in the temporary output symbol D9. Accordingly, the transformation unit 150 transforms “the phonetic symbol of IEEE” (the registered symbol) into “IEEE” (the specific symbol) corresponding to “the phonetic symbol of IEEE” in the combination table D7 (FIG. 6). “IEEE”, which is the symbol after the transformation, is output as the output symbol D4.

Next, a significance of the determination unit 120 is described. It is contemplated that the specific symbol in the specific symbol table D2, as is, is regarded as the registered symbol D6 and the bias table D8 is generated, without the determination unit 120 being provided. In other words, in the aforementioned example, the generation unit 130 can generate the bias table D8, using the specific symbol “IEEE,” rather than the registered symbol “the phonetic symbol of IEEE.” To illustrate this with the example of FIG. 7, “IEEE” is associated with the bias value (−3.5) in the bias table D8.

Here, since “IEEE” is a proper noun, it is often the case that the training data E that is used to train the trained model D3 includes zero or a very small amount of data that includes “IEEE.” In this case, the estimation unit 140 estimates that the candidate symbol “IEEE” has a significantly greater score than “i triple e” and “the phonetic symbol of IEEE.”

In this case, it is assumed that even if the estimation unit 140 uses the bias table D8 and adds the bias value to the score of the candidate symbol “IEEE,” the score of the candidate symbol “IEEE” may not be smaller than the score of “i triple e” and the score of “IEEE”. In this case, “IEEE” desired by the user is not output as the output symbol D4.

While the registered symbol “the phonetic symbol of IEEE” is expressed differently from the specific symbol “IEEE,” a large number of individual phonemes of the phonetic symbol are included in the training data. Due to this, the candidate symbol “the phonetic symbol of IEEE” has a smaller score than the specific symbol “IEEE.”

As described above, the registration of specific symbol functions more effectively by generating the bias table D8 using the registered symbol “the phonetic symbol of IEEE,” than generating the bias table D8 using the specific symbol “IEEE.” In other words, a significance of the determination unit 120 is that it transforms the specific symbol into a symbol (the phonetic symbol of IEEE,” in this example) that has a higher likelihood than the specific symbol.

### [Flowchart]

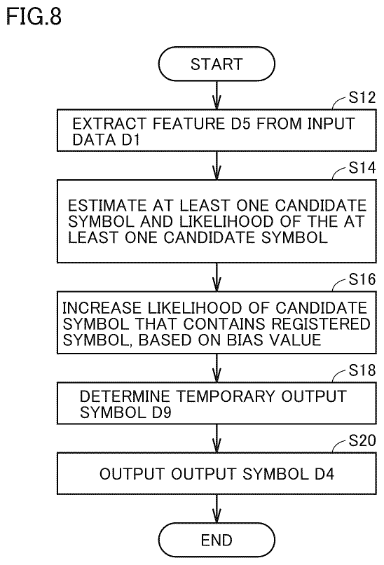

FIG. 8 is a flowchart showing a primary process of the information processing device 100. Initially, in step S12, the information processing device 100 extracts the feature value D5 from the input data D1. Next, in step S14, the information processing device 100 estimates at least one candidate symbol and a likelihood of the at least one candidate symbol.

Next, in step S16, the information processing device 100 performs the increasing process of increasing the likelihood of the candidate symbol that includes the registered symbol D6, based on the bias value. Next, in step S18, the information processing device 100 determines the temporary output symbol D9, based on the likelihood after the increasing process. Next, in step S20, the information processing device 100 transforms the registered symbol included in the temporary output symbol D9 into a specific symbol corresponding to the registered symbol included in the combination table D7, and outputs the specific symbol as the output symbol D4.

### [Training Device]

Next, the training device 200 (see FIG. 3) is described. The training device 200 trains the model E5 when a predetermined start condition is met. The model E5 corresponds to the trained model D3 before the start condition is met. The start condition is met, for example, by the user of the training device 200 performing a predetermined start operation.

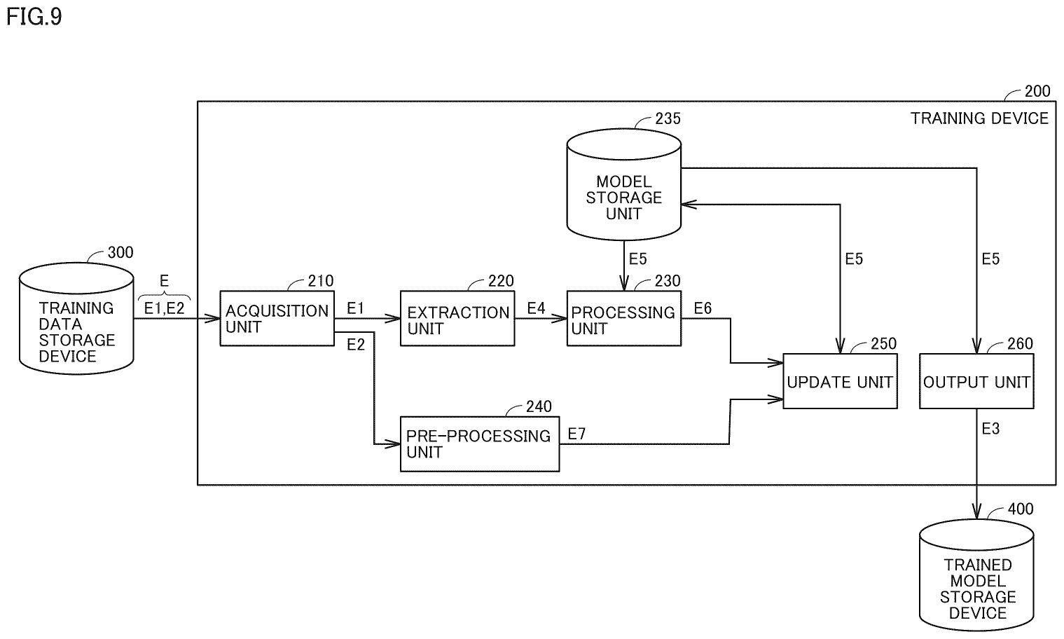

FIG. 9 is a functional block diagram of the training device 200. The training device 200 has an acquisition unit 210, an extraction unit 220, a processing unit 230, a model storage unit 235, a pre-processing unit 240, an update unit 250, and an output unit 260.

The training data storage device 300 stores multiple training data E. The acquisition unit 210 obtains the multiple training data E from the training data storage device 300. The training data E (training data) is configured of training input data E1 which is used to train the model E5, and a first training output symbol E2 corresponding to the training input data E1. For example, the training input data E1 is voice data, and the first training output symbol E2 is text data transcribed from a voice represented by the voice data. The training input data E1 is output to the extraction unit 220, and the first training output symbol E2 is output to the pre-processing unit 240. In the trained model D3, the greater the number of symbols are included in the training output symbol, the higher the likelihood of the candidate symbol that includes that symbol.

The extraction unit 220 extracts from the training input data E1 a feature value E4 that is in a form suitable for input to a model. A specific method of process to extract the feature value E4 from the training input data E1 is the same as the process of the extraction unit 110 (Fig. 4) of the information processing device 100 extracting the feature value D5 from the input data D1.

The model storage unit 235 stores the model E5. The processing unit 230 reads the model E5 from the model storage unit 235, and applies the model E5 to the feature value E4 extracted by the extraction unit 220 to obtain an output symbol E6. For example, the model E5 outputs a score (a likelihood) that indicates which symbol is likely to be output in each frame of the feature value E4. Alternatively, if the model E5 is provided with the feature value E4, information on the symbol that is already output, and information on a candidate symbol to be output next, the model E5 calculates the score in outputting the candidate symbol.

The pre-processing unit 240 applies a predetermined pre-process to the first training output symbol E2 to generate a second training output symbol E7. The pre-process includes, for example, a change process in which the morphological analysis is applied to the transcription to divide the text for each word, and some words (target words) are randomly changed into those expressed in a different way than the word.

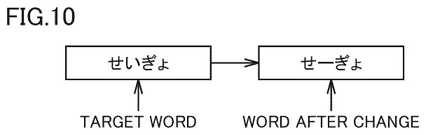

For example, the change process includes a process of changing a target word that is not hiragana into a word expressed in hiragana. The change process also includes a process of changing a target word that is not katakana into a word expressed in katakana. The change process includes a process of changing a target word that is not romaji into a word expressed in romaji. The change process include a process of changing a target word into a word written by lengthening the target word. FIG. 10 is one example of the process of changing the target word into a word written by lengthening the target word.

The pre-process by the pre-processing unit 240 is now further described. As described above, in the information processing device 100, preferentially, the registered symbol has a high likelihood. Here, as noted above, the registered symbol has the same meaning as the specific symbol, and is expressed in a different way than the specific symbol (see FIG. 6).

The first training output symbol E2 is, for example, English text using alphabets. The English text, which is the first training output symbol E2, is for example, text that includes “i triple e”, such as “I attend i triple e.” In the following, the term such as “i triple e” included in English text is a “general word” as described above.

In other words, when the training device 200 uses the first training output symbol E2, as is, to train the model E5, the model E5 is trained so that a high likelihood is assigned to the general word such as “i triple e,” and a low likelihood is assigned to a phonetic symbol.

When the model E5 is trained in this manner, the score (a first score) of the output symbol by the general word may be excessively lower than the score (a second score) of the output symbol by the phonetic symbol. In this case, where the phonetic symbol (e.g., the phonetic symbol of IEEE) is a registered symbol, a first problem may occur that even if the score (the second score) of the registered symbol is reduced by the bias value, the first score does not drop below the second score, and the output symbol by the general word is still output. Where a large value is set to 2 in the mathematical formula for the bias value to bridge the gap in score, a second problem may occur that the registered symbol is falsely output in irrelevant instances.

Thus, assuming such a first problem and second problem, the pre-process performed by the pre-processing unit 240 is a process in which the morphological analysis is applied to the text to divide the text for each word, and some words are selected and transformed into those in different writing. The morphological analysis is one example of a “predetermined process” according to the present disclosure.

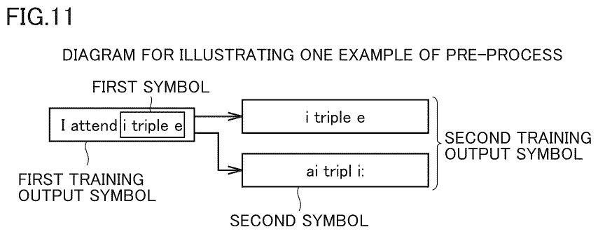

FIG. 11 is a diagram for illustrating the pre-process. In the example of FIG. 11, the text is “I attend i triple e.” The pre-processing unit 240 applies the morphological analysis to the text to divide it into “I,” “attend,” and “i triple e.” Note that the symbol after the division will also be referred to as a unit symbol according to the present disclosure, or, simply, a word.

The pre-processing unit 240 selects “i triple e” as a first symbol. The pre-processing unit 240 transforms “i triple e” into one in a different expression, which is the phonetic symbol of “IEEE.” The phonetic symbol of “IEEE” is one example of a second symbol. This allows the training device 200 to increase the training data (the second symbol) for phonetic symbols. Accordingly, the training device 200 can increase the likelihood of a candidate symbol that includes the training data for phonetic symbols (the second symbol). In other words, the training device 200 can reasonably reduce the score (the second score) of the output symbol by the phonetic symbol, thereby diminishing the difference between the first score and the second score and making the application of the bias value to the registered symbol more effective. The first training output symbol E2 on which the pre-process has been performed by the pre-processing unit 240 will be referred to as a “second training output symbol E7.”

The expression type of the second symbol is designated by the user. The second training output symbol E7 includes a first symbol and a second symbol corresponding to the first symbol. The second symbol may be expressed as being corresponding to a registered symbol. Note that, typically, it is preferable that the second symbol is regarded as the same as the registered symbol. The second symbol may be included in a registered symbol or a registered symbol may be included in the second symbol.

The update unit 250 calculates an error between the output symbol E6 (the output symbol) output from the processing unit 230 and the second training output symbol E7 output from the pre-processing unit 240. Next, the update unit 250 updates the model E5 so that the error diminishes. The update unit 250 outputs a resultant updated model E5 to the model storage unit 235. Here, the function for calculating the error between the output symbol E6 and the second training output symbol E7 is, for example, a cross-entropy error function or a CTC (connectionist temporal classification) error function. In the model update, well-known error backpropagation is used to calculate the gradient in each parameter (the parameter 304) of the model, and an optimization scheme, such as Stochastic Gradient Descent (SGD) or Adam, is used to update the model E5.

After the completion of the training of the model E5, the output unit 260 outputs the model E5, stored in the model storage unit 235, to the trained model storage device 400 as the trained model E3.

### [Flowchart for Training Device]

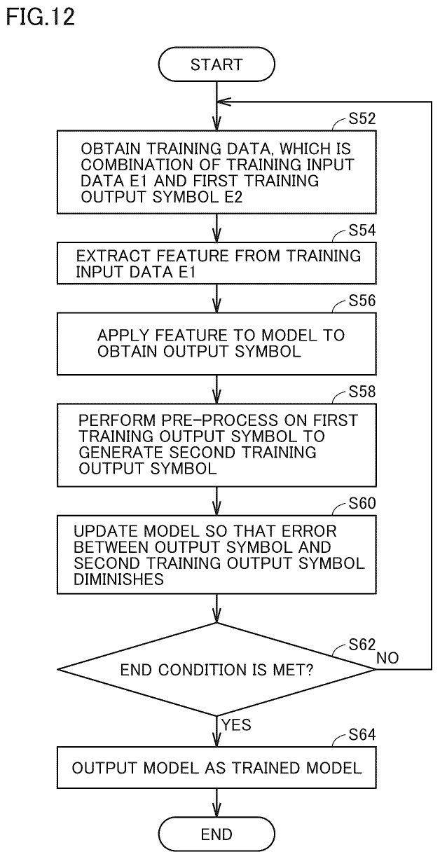

FIG. 12 is a flowchart for the training device 200. In step S52, the training data E, which are a combination of the training input data E1 and the first training output symbol E2, is obtained. Next, in step S54, the training device 200 extracts the feature value E4 from the training input data E1.

Next, in step S56, the training device 200 applies the feature value E4 to the model E5 to obtain the output symbol E6. Next, in step S58, the training device 200 performs the pre-process on the first training output symbol E2 to generate the second training output symbol E7 (see FIG. 11).

Next, in step 60, the training device 200 updates the model E5 so that the error between the output symbol E6 and the first training output symbol E2 diminishes.

Next, the training device 200 determines whether an end condition is met. The end condition, for example, includes a condition that a predetermined amount of training data E has been processed. If the end condition that the training device 200 has processed a predetermined amount of training data E, is met (YES in step S62), the process proceeds to step S64. If the end condition is not met (NO in step S62), in contrast, the process returns to step S52. In step S64, the training device 200 outputs the model E5, updated in step S60, as the trained model E3.

Note that at least one of the information processing device 100 and the training device 200 may be implemented in an on-premises computer or located in the cloud. The information processing device 100 and the training device 200 may be located on the same computer. The information processing device 100 and the training device 200 may be located in different computers. If such a configuration is employed, the training device 200 may output the trained model to the trained model storage device 400 via a network.

### [Summary]

(1) For example, the user may wish a specific symbol, desired by the user, to be to preferentially output to the information processing device, as an output symbol. In this case, since the transformation of the input data into the output symbol sequence is implemented by a single neural network in the information processing device employing the end-to-end model, a customization that allows a partially-changed word to be additionally registered is difficult.

Moreover, since the random replacement process is performed in the technology disclosed in Japanese Patent Laying-Open No. 2022-531615, it is often the case that a specific symbol is not generated in the replacement process. In this case, a problem can arise that it is difficult to output the specific symbol as an output symbol. In other words, it is difficult for a conventional information processing device to allow the specific symbol input by a user to be preferentially output as an output symbol.

Thus, in the present disclosure, the information processing device 100 estimates, from input data, at least one candidate symbol and a likelihood of the at least one candidate symbol. Next, the information processing device 100 performs the increasing process in which the likelihood of the candidate symbol that includes a registered symbol is increased based on the bias module. This allows the registered symbol (or the candidate symbol that includes the registered symbol) to be preferentially determined to be a temporary output symbol. If a registered symbol is included in the temporary output symbol, the information processing device 100 refers to the combination table, performs the transformation process in which the registered symbol is transformed into a specific symbol corresponding to the registered symbol, and outputs the temporary output symbol, on which the transformation process has been performed, as an output symbol.

Accordingly, the customization is facilitated by the user inputting the specific symbol. Moreover, the specific symbol can be preferentially output as the output symbol by the performance of the increasing process for causing the registered symbol to be preferentially output and the replacement process in which the registered symbol is changed to the specific symbol.

Note that if one wishes a specific symbol to be preferentially output as an output symbol, a configuration is contemplated in which the training data that includes a large number of specific symbols is used to update the trained model D3. If such a configuration is employed, however, the information processing device 100 may preferentially output the specific symbol that is not often used, such as a proper noun. The present embodiment can allow the information processing device 100 to cause the specific symbol desired by the user to be preferentially output as an output symbol, without employing such a configuration.

(2) The training device 200 performs a pre-process of generating: the first symbol to be included in the first training output symbol; and the second symbol in which the first symbol is expressed in the expression designated by the user (FIG. 11). Accordingly, the training device 200 can increase the amount of training data that includes the second symbol. Thus, the training device 200 updates the model E3 so that the second symbol (a symbol corresponding to the registered symbol) has a higher likelihood. Accordingly, the training device 200 can update the model so that the second symbol in which the first symbol is expressed by the expression type designated by the user can have an increased likelihood.

### Embodiment 2

Embodiment 2 will be now described with reference to various alternative embodiments to the above configuration.

### [Symbol]

The symbol in Embodiment 1 described above is, primarily, in English. However, the symbol may be expressed in other language. The other language is, for example, Japanese.

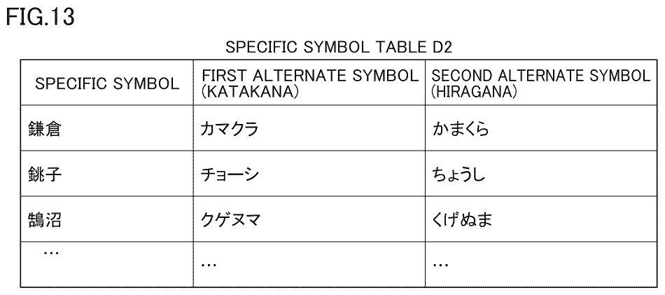

FIG. 13 is one example of the specific symbol table D2 expressed in Japanese. In the example of FIG. 13, proper nouns in kanji are shown as specific symbols. In addition, first symbols expressed in katakana and second symbols expressed in hiragana are shown as alternate symbols.

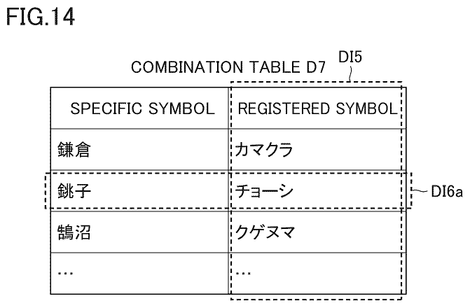

FIG. 14 is one example of the combination table D7 expressed in Japanese. In the example of FIG. 14, proper nouns in kanji are shown as specific symbols. Symbols expressed in katakana are also shown as registered symbols.

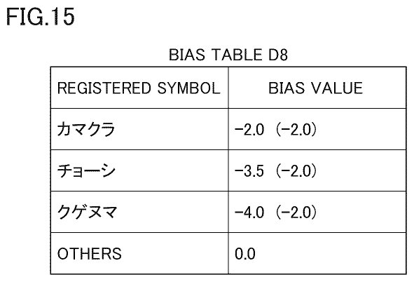

FIG. 15 is one example of the bias table D8 expressed in Japanese. In the example of FIG. 15, a bias value is defined for each of three registered symbols.

### [Table 1]

A flow of a process performed by the information processing device 100 employing such a configuration is described. Assume that a proper noun “ [symbol] ,” which is a place name, is input by the user as a specific symbol. In the following, a configuration is described where the voice is “ [symbol] [symbol] .” Given this configuration, preferably, the symbol “ [symbol] , [symbol] ” is output as the output symbol.

Assume that the estimation unit 140 identifies the following first candidate symbol and second candidate symbol as candidate symbols. Assume that the first candidate symbol is “ [symbol] , [symbol] ,” and the score for the first candidate symbol is “0.0.” “ [symbol] ” is a common noun meaning a state of expression of a word.

Assume also that the second candidate symbol is “ [symbol] , [symbol] ,” and the score for the second candidate symbol is “1.0.” In this example, the first candidate symbol has a smaller score (a higher likelihood) than the second candidate symbol.

In this example, if the bias table D8 of FIG. 15 does not exist, the estimation unit determines the first candidate symbol as a temporary output symbol.

In this example, if the bias table D8 of FIG. 15 exists, in contrast, the second candidate symbol is registered as a registered symbol, as shown in FIG. 14. Accordingly, the estimation unit 140 performs the increasing process of increasing the likelihood of the candidate symbol (the second candidate symbol) based on the bias value (−3.5) corresponding to the registered symbol. In this example, the increasing process is a process in which the process of adding the bias value to the score is performed, and the score is thereby determined to be −2.5.

As such, the estimation unit 140 performs the increasing process of increasing the likelihood of a candidate symbol that includes the registered symbol, among at least one candidate symbol, based on the bias value corresponding to the registered symbol.

The temporary output symbol D9 is determined based on a respective likelihood of at least one candidate symbol on which the increasing process has been performed. In the above example, after the increasing process, the first candidate symbol has a score of “0.0,” and the second candidate symbol has a score of “−2.5.” Accordingly, the estimation unit 140 determines the second candidate symbol as the temporary output symbol D9. The temporary output symbol D9 is input to the transformation unit 150.

If a registered symbol is included in the temporary output symbol D9, the transformation unit 150 refers to the combination table D7 (FIG. 6). The transformation unit 150 performs the transformation process of transforming the registered symbol into a specific symbol corresponding to the registered symbol. The transformation unit 150 outputs the temporary output symbol D9, on which the transformation process has been performed, as the output symbol D4.

### [Table 2]

In the above example, “ [symbol] , [symbol] ” is included in the temporary output symbol D9. Accordingly, the transformation unit 150 refers to the combination table D7 (FIG. 6), and transforms “ [symbol] , [symbol] ” into “ [symbol] , [symbol] ” that includes the specific symbol. The transformation unit 150 outputs, “ [symbol] , [symbol] [symbol] ” which is a symbol after the transformation, as the output symbol D4. As described above, the information processing device 100 can preferentially output a specific symbol appropriately as an output symbol, even if the symbol is in other language.

### [Input Data and Output Symbol]

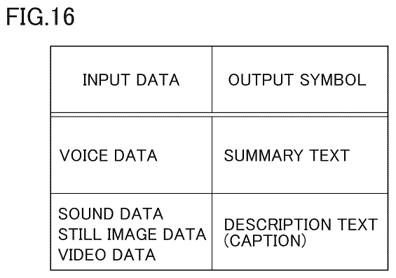

In the above embodiment, the information processing device 100 functions as a voice recognition apparatus. In other words, the input data is voice data, and the output symbol is text of voice represented by the voice data. However, the input data and the output symbol may be other example. FIG. 16 is a diagram showing the other example.

In the example of FIG. 16, if the input data is voice data, the output symbol may be summary data. The summary data is text summarizing text of the voice represented by the voice data. Given such a configuration, the information processing device functions as an audio summary apparatus.

The input data may be any one of sound data (e.g., sound effect data), still image data, or video data. In this case, the output symbol is description text. The description text is text (e.g., a caption) indicating the description of an object. The object is presented by sound by sound data, a still image by the still image data, and a video by video data. Given such a configuration, the information processing device functions as a caption application apparatus.

As shown in FIG. 16, the information processing device 100 according to the present disclosure can use a variety of input data and output symbols.

### [Bias Value Determination Technique]

In the above embodiment, the generation unit 130 uses the N-gram language model, trained using the training output symbol, to determine the bias value. However, the bias value determination technique may be a different technique.

For example, all registered symbols may have the same bias value, as shown in the parentheticals in the bias value column of FIG. 15. In the example of the parentheticals of FIG. 15, all the bias values are −2.0. With such a configuration, since the same bias value is used in the increasing process described above, the increasing process can be simplified.

Moreover, the greater the number of characters are included in the registered symbol, the greater the generation unit 130 may determine to increase the likelihood as the bias value. The bias value that greatly increases the likelihood is a negative value whose absolute value is great in the above described embodiment.

Moreover, the decision model 305 may be a machine-learned model that is trained to receive input of a registered symbol and output a bias value.

Moreover, a configuration in which the user determines the bias value may be employed. The information processing device 100 employing such a configuration may use the input device 4 (see FIG. 2) to allow input of the bias value. If such a configuration is employed, a bias value for the registered symbol already stored in the information processing device 100 may be input (set). Moreover, the user may use the input device 4 (see FIG. 2) to input the information in which the registered symbol and the bias value are associated.

### [Pre-Process]

FIG. 11 describes the pre-process in which the first symbol is randomly selected from among multiple unit symbols determined by the predetermined operation (the morphological analysis, etc.).

However, the pre-process may be other process insofar as the process increases the likelihood of the candidate symbol that includes the registered symbol. For example, in the pre-process, the unit symbol determined to be a noun or a proper noun may be selected as the first symbol from among divided unit symbols. This is because, in general, the unit symbol (the specific symbol) desired by the user to be registered is often a noun or a proper noun that is difficult to read.

In the example of FIG. 11, the unit symbol (a proper noun only) “i triple e” is selected as the first symbol from among the first training output symbols, and the proper noun is transformed into the second training output symbol.

The pre-process also identifies the number of unit symbols that are included in each of all the first training output symbols E2. Here, the first training output symbol E2 is at least one of the symbol after being used in the training device 200 and the symbol before being used in the training device 200. This is because, in general, the unit symbol (the specific symbol) desired by the user to be registered is often a unit symbol a small number of which is included in the first training output symbol E2.

In the example of FIG. 11, among the first training output symbols, the number of unit symbols, which are “i triple e,” included in the first training output symbol E2 is less than the predetermined value (small). Thus, this unit symbol is selected as the first symbol and transformed into the second training output symbol.

### [Information Applied to Symbol]

The determination unit 120 may apply a predetermined information symbol to the symbol (the registered symbol). The information symbol is a symbol that has a predetermined meaning. The information symbol includes a start symbol indicating the beginning of a registered symbol and an end symbol indicating the beginning of the registered symbol. The start symbol ‘<bob>’ indicates an abbreviation of beginning of biasing, meaning the beginning of a registered symbol. The end symbol ‘<eob>’ is an abbreviation of end of biasing, meaning the end of the registered symbol. As such, the determination unit 120 can apply the start symbol and the end symbol to a registered symbol to clearly identify the registered symbol.

The pre-processing unit 240 may also apply a probable symbol to the first symbol. The probable symbol is a symbol that indicates a probability (a ratio) of a first symbol of being replaced with a second symbol.

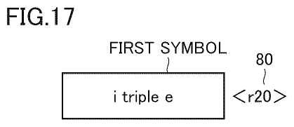

FIG. 17 is a diagram illustrating one example of the probable symbol 80. In FIG. 17, the probable symbol 80<r20> is applied to the first symbol. What is indicated by <r20> is that the first symbol has a 20% probability of being replaced with the second symbol. In other words, in the example of FIG. 17, the first symbol is replaced with the second symbol once in five times. Note that the probable symbol 80 may be designated by the user or the training device 200 may determine the probable symbol 80 by predetermined operations.

### [Registered Symbol Determination Technique]

(1) There may be multiple specific symbols (e.g., the case of FIG. 13). In this case, considering the performance of the registered symbol registration process, the determination unit 120 may change the method of determination of the registered symbol for each specific symbol. For example, for a first specific symbol among multiple specific symbols, the determination unit 120 may determine the first specific symbol itself as a registered symbol. For the second specific symbol among multiple specific symbols, the determination unit 120 may determine a symbol different from the second specific symbol, as a registered symbol.

[Table 3]

[symbol]

(2) For Japanese voice recognition, there are words such as “ [symbol] ” pronouncing the same as “ [symbol] ,” besides “ [symbol] .” In this situation, if the determination unit 120 determines “ [symbol] ” as a registered symbol for “ [symbol] ,” the estimation unit 140 can output “ [symbol] ” as the temporary output symbol D9, even for the symbol that should be output as “ [symbol] .” In this case, after the performance of the transformation process by the transformation unit 150, many of the words that should be output as “ [symbol] ” can be output as “ [symbol] .” Even if “ [symbol] ” is registered as a registered symbol, “ [symbol] ,” rather than “ [symbol] ,” may be determined as a registered symbol if the estimation unit 140 is able to preferentially output “ [symbol] .” The method of determination of the registered symbol may be a method of determination that can reduce the cases where the word that should be “ [symbol] ” is falsely “ [symbol] .”

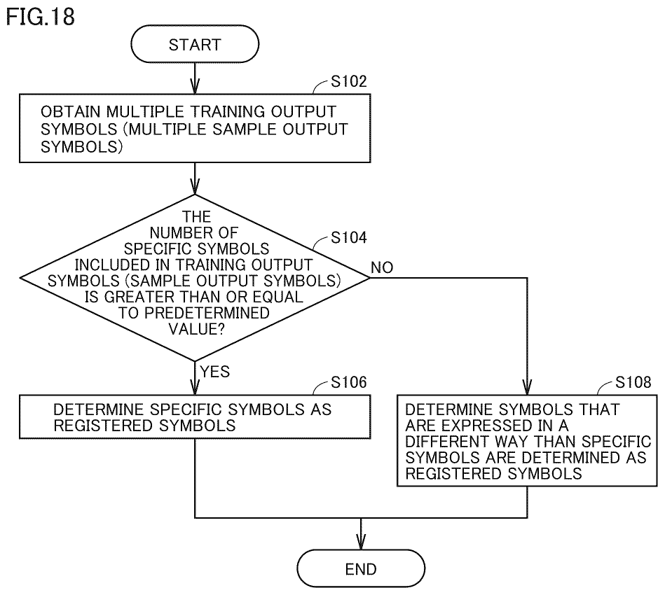

(3) The registered symbol D6 determination technique by the determination unit 120 (the information processing device 100) is not limited to the above embodiment, and may be other technique. FIG. 18 is one example of a flowchart of a first technique of determination of the registered symbol D6. In the example of FIG. 18, multiple training output symbols (e.g., the first training output symbols E2) are used. The training output symbol is at least one of a symbol after being used in the training device 200 and a symbol before being used in the training device 200.

In step S102, the determination unit 120 obtains multiple training output symbols. Next, in step S104, the determination unit 120 identifies the number of specific symbols that are included in the training output symbols and determines whether the number of specific symbols is greater than or equal to a predetermined value. If the number of specific symbols is greater than or equal to the predetermined value, the process proceeds to step S106. If the number of specific symbols is less than the predetermined value, the process proceeds to step S108.

In step S106, the determination unit 120 determines the specific symbol as a registered symbol. For example, in the example of FIG. 5, “IEEE” itself, which is a specific symbol, is stored as the registered symbol D6. The process of FIG. 18 then ends. In step S106, in contrast, the determination unit 120 determines, as a registered symbol, a symbol that is expressed in a different way than the specific symbol. For example, in the example of FIG. 5, “the phonetic symbol of IEEE” corresponding to “IEEE,” which is the specific symbol, is stored as the registered symbol D6.

Next, a significance of the flowchart of FIG. 18 is described. If the number of specific symbols included in the training output symbols is greater than or equal to the predetermined value (YES in step S104 of FIG. 18), the candidate symbol that includes the specific symbol tends to have a high likelihood. In such a case, the specific symbol can be preferentially output as a temporary output symbol by determining the specific symbol as the registered symbol. Note that, in this case, since the specific symbol is output as a temporary output symbol, the replacement process is not performed.

If the number of specific symbols included in the training output symbols is less than the predetermined value (NO in step S104 of FIG. 18), in contrast, the candidate symbol that includes the specific symbol tends to have a low likelihood. In such a case, the specific symbol can be preferentially output as a temporary output symbol by determining the specific symbol as the registered symbol.

(4) The determination unit 120 may use multiple sample output symbols, rather than multiple (N: N is an integer greater than or equal to 2) training output symbols, as indicated in the parentheticals of FIG. 18. As the sample output symbol, for example, the user inputs N input data (sample input data) to the information processing device 100 and the information processing device 100 is caused to output N sample output symbols as output symbols. With the configuration according to the configuration of the parentheticals FIG. 18, the determination unit 120 uses the N sample output symbols.

Next, a significance of the configuration of the parentheticals FIG. 18 is described. If the number of specific symbols included in the sample output symbols is greater than or equal to the predetermined value (YES in step S104 of FIG. 18), the candidate symbol that includes the specific symbol tends to have a high likelihood. In such a case, the specific symbol can be preferentially output as a temporary output symbol by determining the specific symbol as the registered symbol. Note that, in this case, since the specific symbol is output as a temporary output symbol, the replacement process is not performed.

If the number of specific symbols included in the sample output symbols is less than the predetermined value (NO in step S104 of FIG. 18), in contrast, the candidate symbol that includes the specific symbol tends to have a low likelihood. In such a case, the registered symbol can be preferentially output as a temporary output symbol by determining a symbol, expressed differently from the specific symbol, as a registered symbol.

With the configuration of the parentheticals FIG. 18, the registered symbol D6 can also be determined so that each specific symbol included in the specific symbol table D2 can be output as the temporary output symbol D9 as often as possible. With the configuration of the parentheticals FIG. 18, the number of specific symbols, each included in the specific symbol table D2, which are falsely output as an output symbol can be reduced.

### [Output Symbol]

For example, as the method of determination of the registered symbol D6 is changed, the output symbol D4 can be changed accordingly, as shown in FIG. 18. Thus, the information processing device 100, if it changes the method of determination of registered symbol, may determine multiple output symbols D4, select the best output symbol from among the output symbols D4, and output the best output symbol.

### [Combination Table and Bias Table]

In the above embodiment, the information processing device 100 itself generates the combination table and the bias table. However, at least one of the combination table and the bias table may be generated by other device.

### [Additional Note]

The parentheticals described below are merely one example, and the present disclosure is not limited thereto.

(1) The information processing device according to the present disclosure transforms input data (the input data D1) into an output symbol (the output symbol D4) and outputs the output symbol. The information processing device includes: an interface for receiving a user input of the input data; a memory storing a trained model; and a processor. The processor extracts a feature value (the feature value E5) from the input data. The processor applies the feature value to the trained model to estimate at least one candidate symbol (“i triple e,” and “the phonetic symbol of IEEE”) and a likelihood of the at least one candidate symbol. The memory stores a combination table (the combination table D7 of FIG. 6) and a bias module (the bias table D8 of FIG. 7). The combination table indicates a combination of a specific symbol designated by the user and a registered symbol corresponding to the specific symbol. The bias module increases a likelihood of a candidate symbol that includes the registered symbol. The processor further performs, using the bias module, an increasing process of increasing the likelihood of the candidate symbol that includes the registered symbol, among the at least one candidate symbol. The processor determines a temporary output symbol (the temporary output symbol D9) based on a respective likelihood of the at least one candidate symbol after the increasing process is performed. When the registered symbol is included in the temporary output symbol, the processor refers to the combination table, performs the transformation process of transforming the registered symbol into the specific symbol corresponding to the registered symbol, and outputs, as an output symbol (the output symbol D4), the temporary output symbol on which the transformation process has been performed.

For example, the user may have a symbol (the above specific symbol) that he/she wishes to be preferentially output from the information processing device as an output symbol. In this case, since the transformation of the input data into the output symbol sequence is implemented by a single neural network in the information processing device employing the end-to-end model, a customization that allows a partially-changed word to be additionally registered is difficult.

In the technology disclosed in Japanese Patent Laying-Open No. 2022-531615, it is often the case that the specific symbol registration is not generated by the replacement process. In this case, a problem can arise that it is difficult to output the specific symbol as an output symbol. In other words, it is difficult for a conventional information processing device to allow the specific symbol input by a user to be preferentially output as an output symbol.

Thus, in the present disclosure, the information processing device estimate at least one candidate symbol and a likelihood of the at least one candidate symbol, from the input data. Next, the information processing device performs an increasing process of increasing the likelihood of the candidate symbol that includes the registered symbol, based on the bias module. This allows the registered symbol (or a symbol that includes the registered symbol) to be preferentially determined as the temporary output symbol. If the registered symbol is included in the temporary output symbol, the information processing device refers to the combination table, performs the transformation process of transforming the registered symbol into a specific symbol corresponding to the registered symbol, and outputs the temporary output symbol, on which the transformation process has been performed, as an output symbol.

Accordingly, the customization can be facilitated by the specific symbol being input. The performance of the increasing process for causing the registered symbol to be preferentially output and the performance of the replacement process of changing the registered symbol to the specific symbol allow the specific symbol to be preferentially output as the output symbol.

(2) Preferably, the bias module is a bias table (FIG. 7) in which the bias value for increasing the likelihood of the candidate symbol that includes the registered symbol and the registered symbol are defined in association with each other.

With such a configuration, the bias value corresponding to the registered symbol can be reflected to the likelihood to perform the increasing process.

(3) Preferably, the trained model is trained based on the multiple training data, the multiple training data being a combination of a training feature value and a training registered symbol. The memory stores a decision model (the decision model 305) which outputs a bias value in response to the registered symbol being input to the decision model. The decision model outputs a bias value that is configured in such a manner that the less the number of registered symbols are included in the training registered symbol, the greater the likelihood of the candidate symbol that includes the registered symbol is. The processor generates the bias table by associating the bias value output from the decision model with the registered symbol which is the same as the training registered symbol.

With such a configuration, the decision model is used which outputs the bias value configured in such a manner that the less the number of training registered symbols, the greater the likelihood of the candidate symbol that includes the registered symbol is. The processor generates the bias table by associating the bias value output from the decision model with the registered symbol which is the same as the training registered symbol. Accordingly, even if the candidate symbol that includes the registered symbol has a low likelihood, the likelihood can be increased by the increasing process.

(4) Preferably, the processor generates the bias table based on a user input (the input device 4).

With such a configuration, the bias table defining the bias value as desired by the user can be generated.

(5) Preferably, the bias table defines a same bias value for multiple registered symbols (see the parentheticals of FIG. 15).

With such a configuration, since the same bias value is applied, the increasing process can be simplified.

(6) Preferably, the processor generates the bias module (the process by the generation unit 130 of FIG. 4).

With such a configuration, the information processing device itself can generate the bias module.

(7) Preferably, the interface receives a user input of the specific symbol. The processor generates, as the combination table, a table indicating a combination of the specific symbol input to the interface and the registered symbol corresponding to the specific symbol (the process of the determination unit 120).

With such a configuration, the information processing device itself can generate the combination table.

(8) Preferably, the interface obtains multiple sample output symbols which are output by multiple sample input data being applied to the information processing device (the parentheticals of FIG. 18). When the number of specific symbols included in the multiple sample output symbols is greater than or equal to a predetermined value (YES in step S104), the processor determines the specific symbol as the registered symbol. When the number of specific symbols included in the multiple sample output symbols is less than the predetermined value (NO in step S104), The processor determines a symbol that is expressed differently from the specific symbol, as the registered symbol.

With such a configuration, if the specific symbol included in the sample output symbols is greater than or equal to the predetermined value, the candidate symbol that includes the specific symbol tends to have a high likelihood. In such a case, the specific symbol can be preferentially output as a temporary output symbol by determining the specific symbol as the registered symbol. Note that, in this case, since the specific symbol is output as a temporary output symbol, the replacement process is not performed.

If the specific symbol included in the sample output symbols is less than the predetermined value, in contrast, the candidate symbol that includes the specific symbol tends to have a low likelihood. In such a case, the specific symbol can be preferentially output as a temporary output symbol by determining the specific symbol as the registered symbol.

(9) Preferably, the trained model is a model trained based on the multiple training data, the multiple training data being a combination of training input data and a training output symbol. The interface obtains multiple training output symbols (FIG. 18). When the number of specific symbols included in the training output symbols is greater than or equal to the predetermined value (YES in step S104), the processor determines the specific symbol as the registered symbol. When the number of specific symbols included in the training output symbols is less than the predetermined value (NO in step S104), the processor determines a symbol that is expressed differently from the specific symbol, as the registered symbol.

With such a configuration, if the number of specific symbols included in the training output symbols is greater than or equal to the predetermined value, the candidate symbol that includes the specific symbol tends to have a high likelihood. In such a case, the specific symbol can be preferentially output as a temporary output symbol by determining the specific symbol as the registered symbol. Note that, in this case, since the specific symbol is output as a temporary output symbol, the replacement process is not performed.

If the number of specific symbols included in the training output symbols is less than the predetermined value, in contrast, the candidate symbol that includes the specific symbol tends to have a low likelihood. In such a case, the registered symbol can be preferentially output as a temporary output symbol by determining a symbol expressed differently from the specific symbol as the registered symbol.

(10) Preferably, the increasing process is a process in which the likelihood of the candidate symbol that does not include the registered symbol, among the at least one candidate symbol, is not increased (See section “OTHERS” of FIG. 15).

With such a configuration, an increase in likelihood of the candidate symbol that does not include the registered symbol can be minimized. Consequently, the candidate symbol that includes the registered symbol can be preferentially determined as the temporary output symbol.

(11) Preferably, the registered symbol is the same as the specific symbol, expressed in a different way than the specific symbol, or has the same reading as the specific symbol but is expressed in a different way than the specific symbol (see FIGS. 6 and 14).

With such a configuration, the registered symbol that is any one of the above can be defined.

(12) Preferably, the specific symbol is expressed in any one of hiragana, katakana, romaji, English, or international phonetic alphabets, and the registered symbol is expressed in other one (see FIGS. 6 and 14).

With such a configuration, the specific symbol and the registered symbol can be expressed in hiragana, katakana, romaji, English, and international phonetic alphabets.

(13) Preferably, the input data is voice data. The output symbol is text of a voice represented by the voice data, text summarizing content of the voice represented by the voice data (see FIG. 16).

With such a configuration, text of the voice, or text summarizing content of the voice can be output.

(14) Preferably, the input data is any one of sound data, still image data, or video data. The output symbol is text indicating a description of an object represented by the input data (see FIG. 16).

With such a configuration, the text indicating the description of the object represented by the input data can be output.

(15) The training device according to the present disclosure is a training device for updating a model. The training device includes: an interface for obtaining training data, the training data being a combination of training input data (the training input data E1) and a first training output symbol (the first training output symbol E2): and a processing device. The processing device extracts a feature value (the feature value E4) from the training input data. The processing device applies the feature value to the model to obtain an output symbol (the output symbol E6). The processing device performs a pre-process (FIG. 11) on the first training output symbol to generate a second training output symbol. The processing device updates the model so that an error between the output symbol and the second training output symbol diminishes. The pre-process is a process in which: a first symbol included in the first training output symbol; and a second symbol in which the first symbol is expressed in a way designated by a user are generated (FIG. 11).

With such a configuration, as the pre-process, a process is performed in which: the first symbol to be included in the first training output symbol; and the second symbol in which the first symbol is expressed in the expression designated by the user are generated. The processing device further updates the model so that the second symbol has a higher likelihood. Accordingly, the model can be updated so that the second symbol in which the first symbol is expressed in the expression designated by the user can have an increased likelihood.

(16) Preferably, the second symbol is the same as the first symbol, expressed in a different way than the specific symbol, or has the same reading as the specific symbol but is expressed in a different way than the specific symbol (FIG. 11).

With such a configuration, the second symbol which is any one of the above, can be defined.

(17) Preferably, the first training output symbol is text. The pre-process performs a predetermined process on the text to divide the text for each unit symbol, and selects the unit symbol as the first symbol (FIG. 11).

With such a configuration, if the first training output symbol is text, a word included in the text can be selected as the first symbol.

(18) Preferably, the unit symbol is a noun or a proper noun (FIG. 11).

With such a configuration, the model can be updated so that the second symbol corresponding to the first symbol, which is a noun or a proper noun, can have an increased likelihood.

(19) Preferably, when the number of unit symbols included in the first training output symbol is less than the predetermined value, the pre-process selects the unit symbol as the first symbol (FIG. 11).

With such a configuration, even if a small number of symbols are included in the first training output symbol, the symbol can be selected as the first symbol. Thus, the likelihood of the second symbol corresponding to the first symbol can be increased.

(20) Preferably, the pre-process applies, to the first symbol, information indicating a probability of the first symbol being transformed into the second symbol (see FIG. 17).

With such a configuration, the probability of the first symbol being transformed into the second symbol can be controlled.

The presently disclosed embodiment should be considered as illustrative in all aspects and do not limit the present disclosure. The scope of the present invention is defined by the appended claims, rather than by the above description of the embodiment. All changes which come within the meaning and range of equivalency of the appended claims are intended to be embraced within their scope.

### REFERENCE SIGNS LIST

2 microphone; 3 display; 4 input device; 11 processing unit; 12 memory unit; 13 voice interface; 14 communications unit; 15 display interface; 16 input device interface; 20 removable disk; 30 information processing system;

80 probable symbol; 100 information processing device; 110, 220 extraction unit; 120 determination unit; 130 generation unit; 140 estimation unit; 150 transformation unit; 200 training device; 210 acquisition unit; 230 processing unit; 235 model storage unit; 240 pre-processing unit; 250 update unit; 260 output unit; 300 training data storage device; 301 process program; 303 neural network; 304 parameter; 305 decision model; and 400 trained model storage device.

What is claimed is:

1. An information processing device for transforming input data into an output symbol and outputting the output symbol, the information processing device comprising:
an interface for receiving a user input of the input data;
a memory storing a trained model; and
a processor, wherein
the processor:
extracts a feature value from the input data;
applies the feature value to the trained model to estimate at least one candidate symbol and a likelihood of the at least one candidate symbol, wherein
the memory stores a combination table and a bias module,
the combination table indicates a combination of a specific symbol designated by the user and a registered symbol corresponding to the specific symbol,
the bias module increases a likelihood of a candidate symbol that includes the registered symbol,
the processor further
performs, using the bias module, an increasing process of increasing the likelihood of the candidate symbol that includes the registered symbol, among the at least one candidate symbol, and
determines a temporary output symbol based on a respective likelihood of the at least one candidate symbol after the increasing process is performed, and
when the registered symbol is included in the temporary output symbol, the processor refers to the combination table, performs a transformation process of transforming the registered symbol into the specific symbol corresponding to the registered symbol, and outputs, as the output symbol, the temporary output symbol on which the transformation process has been performed.

2. The information processing device according to claim 1, wherein
the bias module is a bias table in which a bias value for increasing the likelihood of the candidate symbol that includes the registered symbol and the registered symbol are defined in association with each other.

3. The information processing device according to claim 2, wherein
the trained model is trained based on a plurality of training data, the plurality of training data being a combination of a training feature value and a training registered symbol,
the memory stores a decision model which outputs a bias value in response to the registered symbol being input to the decision model,
the decision model outputs a bias value that is configured in such a manner that the less the number of the input registered symbols are included in the training registered symbol, the greater the likelihood of the candidate symbol that includes the registered symbol is, and
the processor generates the bias table by associating the bias value output from the decision model with the registered symbol which is the same as the training registered symbol.

4. The information processing device according to claim 2, wherein
the processor generates the bias table based on a user input.

5. The information processing device according to claim 2, wherein
the bias table defines a same bias value for a plurality of the registered symbols.

6. The information processing device according to claim 1, wherein
the processor generates the bias module.

7. The information processing device according to claim 1, wherein
the interface receives a user input of the specific symbol, and
the processor generates, as the combination table, a table indicating a combination of the specific symbol input to the interface and the registered symbol corresponding to the specific symbol.

8. The information processing device according to claim 1, wherein
the interface obtains a plurality of sample output symbols which are output by a plurality of sample input data being applied to the information processing device, wherein
when the number of the specific symbols included in the plurality of sample output symbols is greater than or equal to a predetermine value, the processor determines the specific symbol as the registered symbol, and
when the number of the specific symbols included in the plurality of sample output symbols is less than the predetermined value, the processor determines a symbol that is expressed differently from the specific symbol, as the registered symbol.

9. The information processing device according to claim 1, wherein
the trained model is a model trained based on a plurality of training data, the plurality of training data being a combination of training input data and a training output symbol,
the interface obtains the plurality of training output symbols, wherein
when the number of the specific symbols included in the plurality of training output symbols is greater than or equal to a predetermined value, the processor determines the specific symbol as the registered symbol, and
when the number of the specific symbols included in the plurality of training output symbols is less than the predetermined value, the processor determines a symbol that is expressed differently from the specific symbol, as the registered symbol.

10. The information processing device according to claim 1, wherein
the increasing process is a process in which a likelihood of a candidate symbol that does not include the registered symbol, among the at least one candidate symbol, is not increased.

11. The information processing device according to claim 1, wherein
the registered symbol is the same as the specific symbol, expressed in a different way than the specific symbol, or has the same reading as the specific symbol but is expressed in a different way than the specific symbol.

12. The information processing device according to claim 10, wherein
the specific symbol is expressed in any one of hiragana, katakana, romaji, English, or international phonetic alphabets, and the registered symbol is expressed in other one.

13. The information processing device according to claim 1, wherein
the input data is voice data, and
the output symbol is text of a voice represented by the voice data, or text summarizing content of the voice represented by the voice data.

14. The information processing device according to claim 1, wherein
the input data is any one of sound data, still image data, or video data, and
the output symbol is text indicating a description of an object represented by the input data.

15. A training device for updating a model, the training device comprising:
an interface for obtaining training data, the training data being a combination of training input data and a first training output symbol; and
a processor, wherein
the processor:
extracts a feature value from the training input data;
applies the feature value to the model to obtain an output symbol;
performs a pre-process on the first training output symbol to generate a second training output symbol; and
updates the model so that an error between the output symbol and the second training output symbol diminishes, wherein
the pre-process is a process in which: a first symbol included in the first training output symbol; and a second symbol in which the first symbol is expressed in a way designated by a user are generated.

16. The training device according to claim 15, wherein
the second symbol is the same as the first symbol, expressed in a different way than the specific symbol, or has the same reading as the specific symbol but is expressed in a different way than the specific symbol.

17. The training device according to claim 15, wherein
the first training output symbol is text,
the pre-process performs a predetermined process on the text to divide the text for each unit symbol, and selects the unit symbol as the first symbol.

18. The training device according to claim 17, wherein
the unit symbol is a noun or a proper noun.

19. The training device according to claim 15, wherein
when the number of unit symbols included in the first training output symbol is less than a predetermined value, the pre-process selects the unit symbol as the first symbol.

20. The training device according to claim 15, wherein
the pre-process applies, to the first symbol, information indicating a probability of the first symbol being transformed into the second symbol.

21. An information processing method for transforming input data into an output symbol and outputting the output symbol, wherein
a bias module increases a likelihood of a candidate symbol that includes a registered symbol, and
a combination table indicates a combination of a specific symbol designated by a user and a registered symbol corresponding to the specific symbol,
the information processing method comprising:
extracting a feature value from the input data;
applying the feature value to a trained model to estimate at least one candidate symbol and a likelihood of the at least one candidate symbol;
performing, using the bias module, an increasing process of increasing the likelihood of the candidate symbol that includes the registered symbol corresponding to the specific symbol designated by the user, among the at least one candidate symbol;
performing, using the bias module, an increasing process of increasing the likelihood of the candidate symbol that includes the registered symbol, among the at least one candidate symbol;
determining a temporary output symbol based on a respective likelihood of the at least one candidate symbol after the increasing process is performed; and
when the registered symbol is included in the temporary output symbol, referring to the combination table, performing a transformation process of transforming the registered symbol into the specific symbol corresponding to the registered symbol, and outputting, as the output symbol, the temporary output symbol on which the transformation process has been performed.

22. A training method for updating a model, comprising:
obtaining training data, the training data being a combination of training input data and a first training output symbol;
extracting a feature value from the training input data;
applying the feature value to the model to obtain an output symbol;
performing a pre-process on the first training output symbol to generate a second training output symbol; and
updating the model so that an error between the output symbol and the second training output symbol diminishes, wherein
the pre-process is a process in which: a first symbol included in the first training output symbol; and a second symbol in which the first symbol is expressed in a way designated by a user are generated.

23. A non-transitory recording medium storing a program for causing a computer to transform input data into an output symbol and output the output symbol, wherein
a bias module increases a likelihood of a candidate symbol that includes a registered symbol, and
a combination table indicates a combination of a specific symbol designated by a user and a registered symbol corresponding to the specific symbol,
the program causes the computer to:
extract a feature value from the input data;
apply the feature value to a trained model to estimate at least one candidate symbol and a likelihood of the at least one candidate symbol;
perform, using the bias module, an increasing process of increasing the likelihood of the candidate symbol that includes the registered symbol corresponding to the specific symbol designated by the user, among the at least one candidate symbol;
perform, using the bias module, an increasing process of increasing the likelihood of the candidate symbol that includes the registered symbol, among the at least one candidate symbol; and
determine a temporary output symbol based on a respective likelihood of the at least one candidate symbol after the increasing process is performed, and
when the registered symbol is included in the temporary output symbol, the program causes the computer to refer to the combination table, perform a transformation process of transforming the registered symbol into the specific symbol corresponding to the registered symbol, and output, as the output symbol, the temporary output symbol on which the transformation process has been performed.

24. A non-transitory recording medium storing a program for causing a computer to update a model, wherein
the program causes the computer to:
obtain training data, the training data being a combination of training input data and a first training output symbol;
extract a feature value from the training input data;
apply the feature value to the model to obtain an output symbol;
perform a pre-process on the first training output symbol to generate a second training output symbol; and
update the model so that an error between the output symbol and the second training output symbol diminishes, wherein
the pre-process is a process in which: a first symbol included in the first training output symbol; and a second symbol in which the first symbol is expressed in a way designated by a user are generated.
